(19) United States
(12) Patent Application Publication
(10) Pub. No.: US 2016/0311104 A1
(43) Pub. Date: Oct. 27, 2016

(54) SINGLE-SHOT TYPE AIR HAMMER TOOL AND METHOD OF ADJUSTING STRIKING FORCE THEREOF

(71) Applicant: Apuren Co., Ltd., Toyota-shi (JP)

(72) Inventors: Yukio WATANABE, Toyota-shi (JP); Shuya ASANO, Toyota-shi (JP)

(73) Assignee: Apuren Co., Ltd., Toyota-shi (JP)

(21) Appl. No.: 15/139,271

(22) Filed: Apr. 26, 2016

(30) Foreign Application Priority Data
Apr. 27, 2015 (JP) 2015-90092

(51) Int. Cl. B25D 17/06; B25D 9/04

(52) U.S. Cl. CPC B25D 17/06; B25D 9/04; B25D 2217/0023; B25D 2250/021; B25D 2250/105

(57) ABSTRACT

A partially-removed ring body is arranged at the predetermined position facing the hammer in a stop position of the cylinder, and a part of the partially-removed ring body protrudes toward the inside of the cylinder. In addition, a recessed groove is formed in the position corresponding to the partially-removed ring body of the hammer at the stop position, and the recessed groove catches the partially-removed ring body, and thus the hammer is positioned at the stop position in the cylinder.

### CROSS-REFERENCE TO RELATED APPLICATIONS

The present application claims priority under 35 U.S.C. §119 to Japanese Patent Application No. 2015-90092, filed Apr. 27, 2015, entitled “Single-shot type air hammer tool and method of adjusting striking force thereof”. The contents of this application are incorporated herein by reference in their entirety.

### BACKGROUND OF THE INVENTION

1. Field of the Invention

The present invention relates to a single-shot type air hammer tool and a method of adjusting a striking force of the single-shot type air hammer tool.

2. Discussion of the Background

Conventionally, an air hammer tool in which compressed air is used as a driving source is known as a hand-type impact tool. Such an air hammer tool has a hammer capable of sliding back and forth and arranged inside a cylinder. The compressed air is introduced to a rear end side of the hammer in the cylinder, and the hammer is pushed forward by the pressure to impact on a chisel attached to the air hammer or a workpiece directly. In order to achieve such an operation of the hammer, airtight spaces are necessary to be formed at the front and the back of the hammer within the cylinder. Thus, an airtight retaining member such as packing is attached to the hammer in a common case.

For example, Japanese Patent Application No. H10-230474 discloses a pneumatic beater including a seal ring attached to a piston (hammer).

In addition, Japanese Patent Application No. 2001-25980 discloses as a pneumatic nailing machine for hammering one nail at one operation by means of air pressure a configuration in which: a cylindrical projection is formed on a back side of the piston (hammer); a circumferential rib is provided on an outer periphery of the projection; a piston catch is disposed on the back side of the piston; when the piston moves backward, the projection on the piston engages with the piston catch to hold the piston in a holding position; and when pressurized air is supplied to the cylinder, the projection on the piston is released from the piston catch by air pressure, and then the machine is activated. In this case, when the configuration is made such that the projection on the piston engages with the piston catch and the piston catch is restrained to be incapable of expanding at the time when the piston returns to the holding position, the piston can always be held in the holding position in a resting state.

### SUMMARY OF THE INVENTION

According to one aspect of the present invention, a single-shot type air hammer tool includes a cylinder, a hammer provided inside the cylinder to freely slide back and forth, an operation switch for introducing compressed air into the cylinder, and an end tool which is mounted in a front side of said cylinder and on which said hammer strikes, for applying striking force to a workpiece with an end of the end tool, in which, when the operation switch is operated once and the compressed air is introduced into the cylinder, said hammer moves forward from a stop position defined in the cylinder to an impact position where the hammer impacts on the end tool arranged at a front of the stop position, and after the hammer impacts on the end tool, the hammer moves backward toward said stop position and again stops at the stop position,

wherein an elastic member is located at a predetermined position that is on an inner peripheral surface of said cylinder and faces to said hammer situated at said stop position so as to protrude at least partially into the cylinder, a recess is set up to a hammer in the location which corresponds to the elastic member and the hammer situated at the stop position so as to catch the elastic member,

the hammer situated at the stop position is urged forward by the pressure of the compressed air introduced due to one operation of said operation switch, a locked state between said recess of the hammer and said elastic member is disengaged, the hammer starts to move forward, the recess of the hammer moving backward from said impact position to the stop position within the cylinder catches the elastic member again, and thus the hammer stops at the stop position,

said elastic member is configured with a partially-removed ring body constructed with an annular wire material made of metal and having a circular cross section in which part of the material is removed, a gap is formed, and thus the partially-removed ring body elastically deforms only in the radial direction to be capable of freely expanding or reducing its inside diameter,

a recess in which said partially-removed ring body is held in an elastically deformable manner only in the radial direction is formed on the inner peripheral surface of said cylinder,

when said hammer is situated at the stop position, the hammer is fitted onto the ring of the partially-removed ring body,

in a state where the hammer situated at said stop position is urged forward, the cross-sectional shape of said wire material does not become deformed in the view that is cut in the plane including a center axis of said partially-removed ring body, the inside diameter of the partially-removed ring body expands, and thus said locked state is disengaged, and the hammer leaves from the partially-removed ring body, and

when the hammer moves backward and fits onto said partially-removed ring body to be locked again, said cross-sectional shape of the wire material forming the partially-removed ring body does not become deformed, and the inside diameter of the partially-removed ring body expands.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a vertical cross-sectional view of the air hammer tool in a normal state according to the reference example 1;

FIG. 2 is a diagram illustrating airflow of the air hammer tool in the normal state;

FIG. 3 is a vertical cross-sectional view showing the air hammer tool when the operation switch is operated;

FIGS. 4A and 4B are diagrams illustrating airflow in the vicinity of the valve in which FIG. 4A shows s state before the switch is operated, and FIG. 4B shows s state after the switch is operated;

FIGS. 5A and 5B are diagrams illustrating engagement states between the recess and the elastic member;

FIG. 6 is a vertical cross-sectional view showing the air hammer tool when the hammer moves forward;

FIG. 7 is a vertical cross-sectional view of the air hammer tool showing the movement of the hammer when the operation switch is pushed down;

FIG. 8 is a vertical cross-sectional view of the air hammer tool showing the movement of the hammer when the operation of the operation switch is released;

FIG. 9 is a vertical cross-sectional view of the air hammer tool according to the reference example 2;

FIG. 10 is a vertical cross-sectional view of the air hammer tool according to the reference example 3;

FIGS. 11A, 11B, and 11C show the elastic member according to the embodiments in which FIG. 11A is a plan view, FIG. 11B is a front view, and FIG. 11C is a cross-sectional view taken along the line A-A in FIG. 11A; and

FIGS. 12A and 12B are diagrams illustrating engagement states between the recess and the elastic member according to the embodiments.

### DESCRIPTION OF THE EMBODIMENTS

The embodiments will now be described with reference to the accompanying drawings, wherein like reference numerals designate corresponding or identical elements throughout the various drawings.

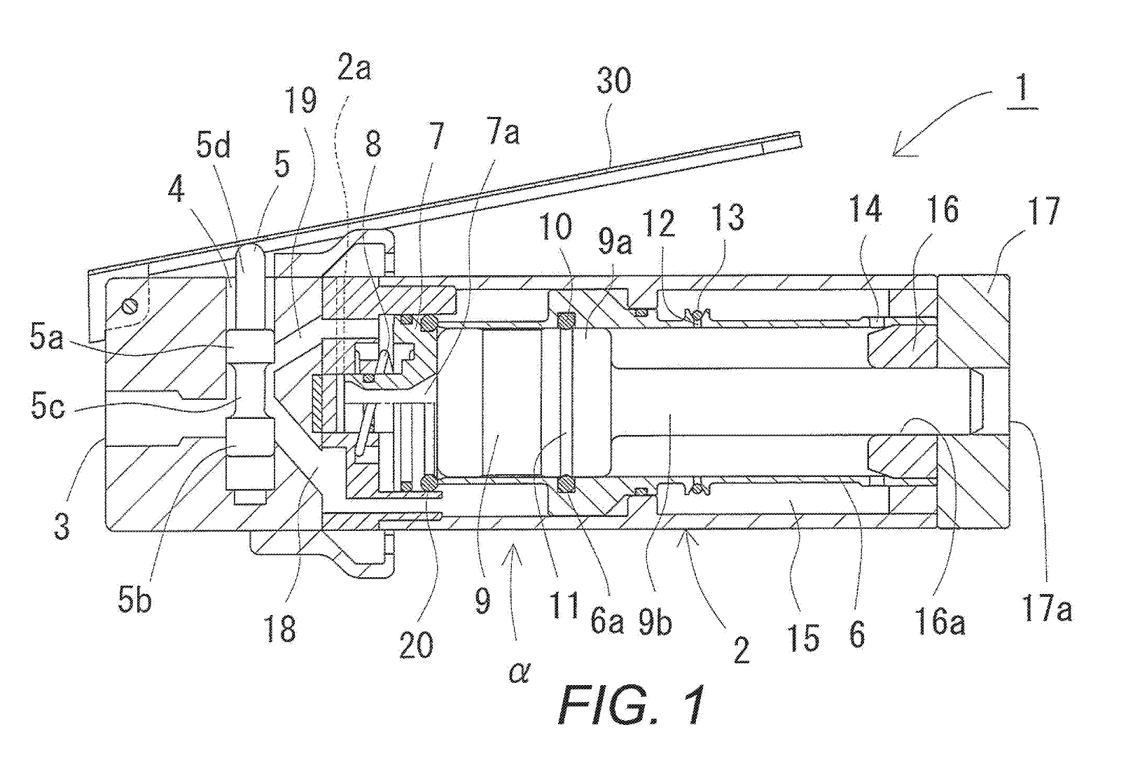

Hereinafter, examples embodying the embodiments of the present invention are described in detail. A scope of the present invention is not limited by the examples described below, and the modification or alteration of the design can be made appropriately. In the description, although directions are descried as being defined as up, down, right, left, front, and back, the scope of the present invention is not merely limited to be used in those directions. With reference to FIG. 1 through FIG. 8, a single-shot type air hammer tool 1 (hereinafter, also simply referred to as “air hammer tool 1”) is described. In the drawings, arrows show the flow of compressed air (the direction of generated pressure).

As shown in FIG. 1, the air hammer tool 1 has a generally cylindrical tool main body 2. A compressed air introduction port 3 is provided at the rear end of the tool main body 2, and the compressed air can be introduced into the tool main body 2 through the compressed air introduction port 3.

A switch hole 4 is formed inside the tool main body 2 so as to be orthogonal to the axial direction of the tool main body 2. The switch hole 4 communicates with the compressed air introduction port 3. In addition, the switch hole 4 opens to the side wall of the tool main body 2. A pin-shaped operation switch 5 is arranged inside the switch hole 4 and provided so as to be retractable in up and down directions with the head part exposed outside.

A stick-shaped operation lever 30 is rotatably mounted on the outer surface of the tool main body 2. The lower surface of the operation lever 30 abuts against the head part of the operation switch 5. When the operation lever 30 is turned up and down, the operation switch 5 is operated up and down.

A generally cylindrical cylinder 6 opened to the front is disposed in a front-side position inside the tool main body 2. A valve 7 is mounted in an interior space between the rear end of the cylinder 6 and the operation switch 5 so as to be movable back and forth. A coil spring 8 oriented in the longitudinal direction is disposed on the outer periphery of the valve 7, and the valve 7 is urged forward by the coil spring 8 to abut against the cylinder 6 through an O-ring 20.

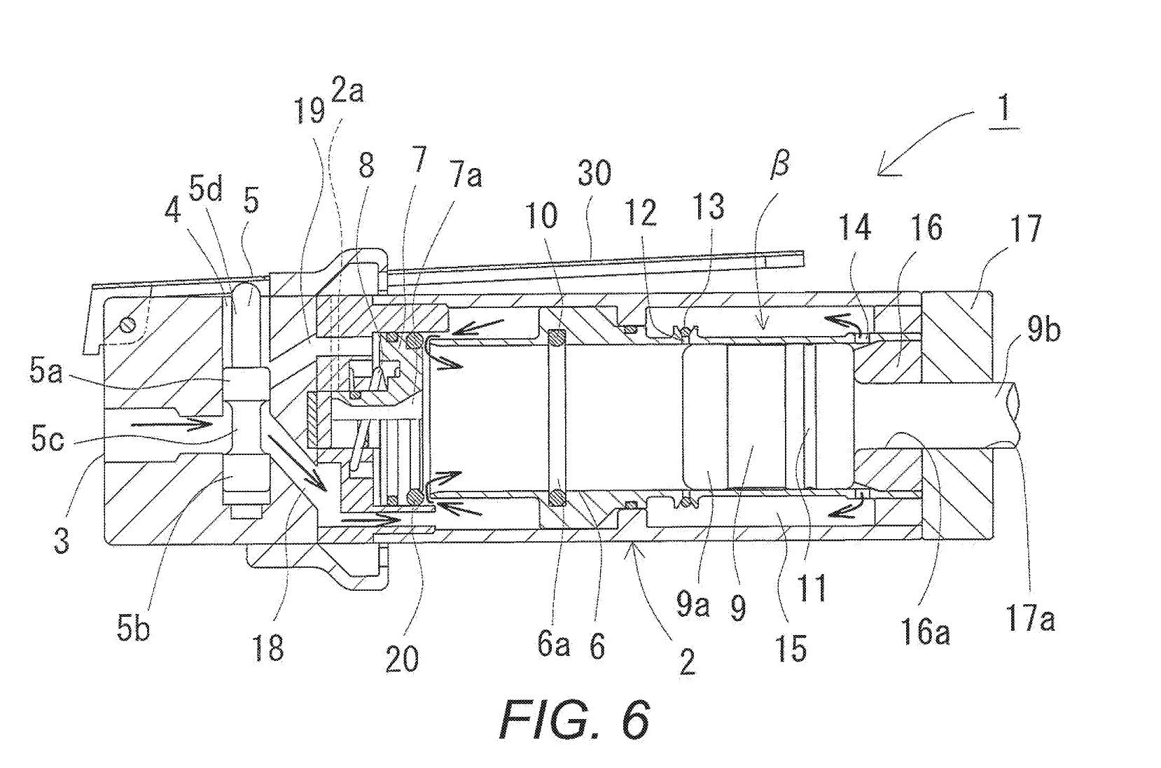

In addition, a hammer 9 is arranged in the cylinder 6 so as to freely slide back and forth. The hammer 9 includes a main body part 9a with a large diameter and a rod part 9b with a small diameter extending from the main body part 9a to the front side. The moving range of the hammer 9 is described in detail here. The position where the hammer 9 is situated at a rearmost end in the cylinder is set as a stop position α as shown in FIG. 1, and the position where the hammer 9 applies the striking force on the workpiece is set as an impact position β as shown in FIG. 6.

Furthermore, as shown in FIG. 1 and other drawings, a first air hole 12 is provided on the side wall of the cylinder 6, and the first air hole 12 communicates with a cylinder side chamber 15 formed between the cylinder 6 and the tool main body 2. An O-ring 13 serving as a one-way valve is attached at the position where the first air hole 12 opens so as to cover the first air hole 12. Specifically, air can flow from the cylinder 6 to the cylinder side chamber 15 through the first air hole 12; however, air cannot flow from the cylinder side chamber 15 to the cylinder 6 reversely.

In addition, a second air hole 14 is provided on the side wall of the cylinder 6 and in the front-side position of the first air hole 12. The second air hole 14 also communicates with the cylinder side chamber 15 similar to the first air hole 12.

A stopper member 16 is mounted in the front end of the cylinder 6, and a blockage member 17 is mounted at the position that is on the front side of the cylinder 6 and is the front end of the tool main body 2. The stopper member 16 and the blockage member 17 respectively include guide holes 16a, 17a formed into which a rod part 9b provided in the hammer 9 can be inserted. The rod part 9b is inserted into the guide holes 16a, 17a at all times, and therefore the airtightness within the cylinder 6 is secured.

The operation switch 5 includes a pair of upper and lower large diameter parts 5a, 5b having outside diameters approximately equal to an inside diameter of the switch hole 4 and a small diameter part 5c formed between the large diameter parts 5a, 5b. In addition, an operating part 5d is formed to protrude from the upper large diameter part 5a toward the side of the operation lever 30.

In the tool main body 2, a cylinder direction path 18 is formed to be directed from the switch hole 4 to the side of the cylinder 6, and a valve direction path 19 is formed to be directed from the switch hole 4 to the side of the valve 7. The O-ring 20 provided in the front end of the valve 7 faces to the cylinder direction path 18 and can change its state between a blocking state and an opening state by the back and forth movement of the valve 7.

In addition, a through hole 7a formed along the longitudinal direction is provided at the center of the valve 7, and the through hole 7a communicates with an airflow passage 2a that is formed on the side wall of the tool main body 2 and communicates with the outside space.

An O-ring 10 as an elastic member (rubber material) is attached along the circumferential direction of the cylinder 6 at a position on the inner peripheral surface of the cylinder 6 and between the valve 7 and the first air hole 12. Specifically, the inner peripheral surface of the cylinder 6 has an O-ring holding recessed groove 6a formed therein for attaching the O-ring 10, and an arrangement is made such that a part of the O-ring 10 protrudes into the inside of the cylinder 6 in the state that the O-ring 10 is placed in the O-ring holding recessed groove 6a.

On the other hand, the outer peripheral surface of the hammer 9 has a groove 11 as a recess annularly formed thereon along the circumferential direction of the hammer 9. In the case where the hammer 9 is situated at the stop position, a part of the O-ring 10 become embedded in the groove 11, and the hammer 9 temporarily engages with the cylinder 6.

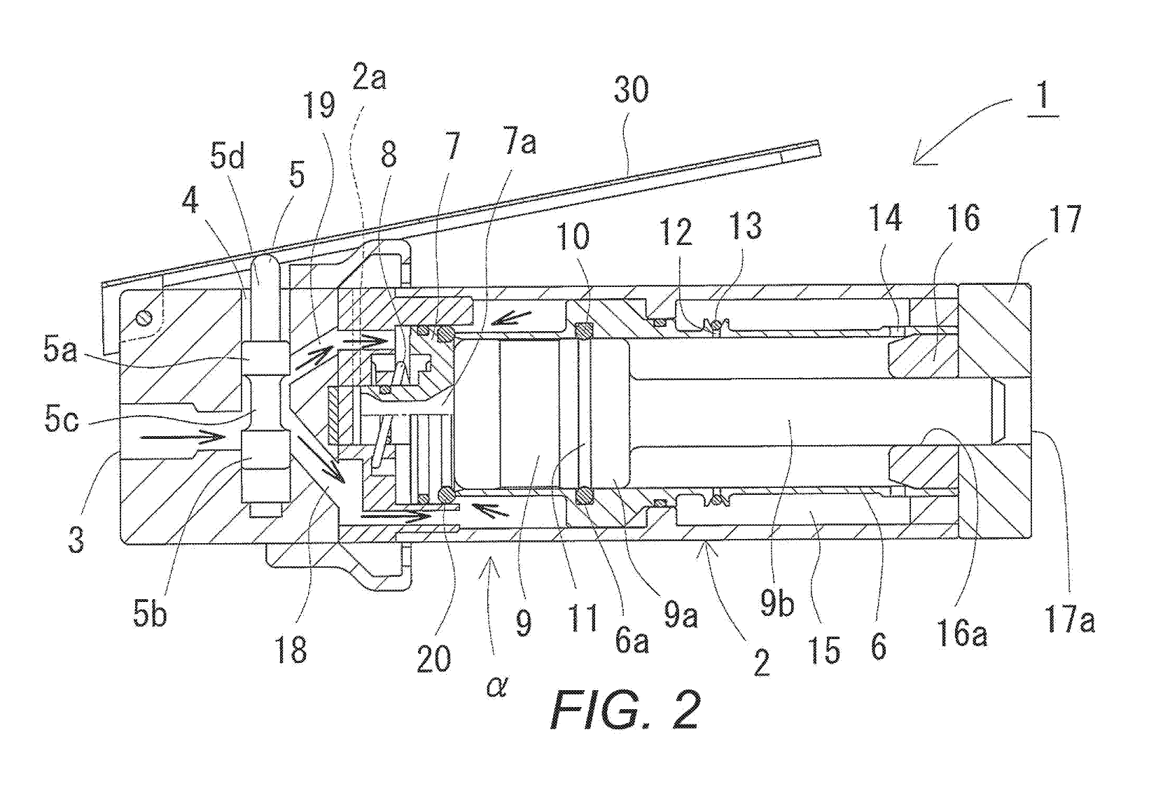

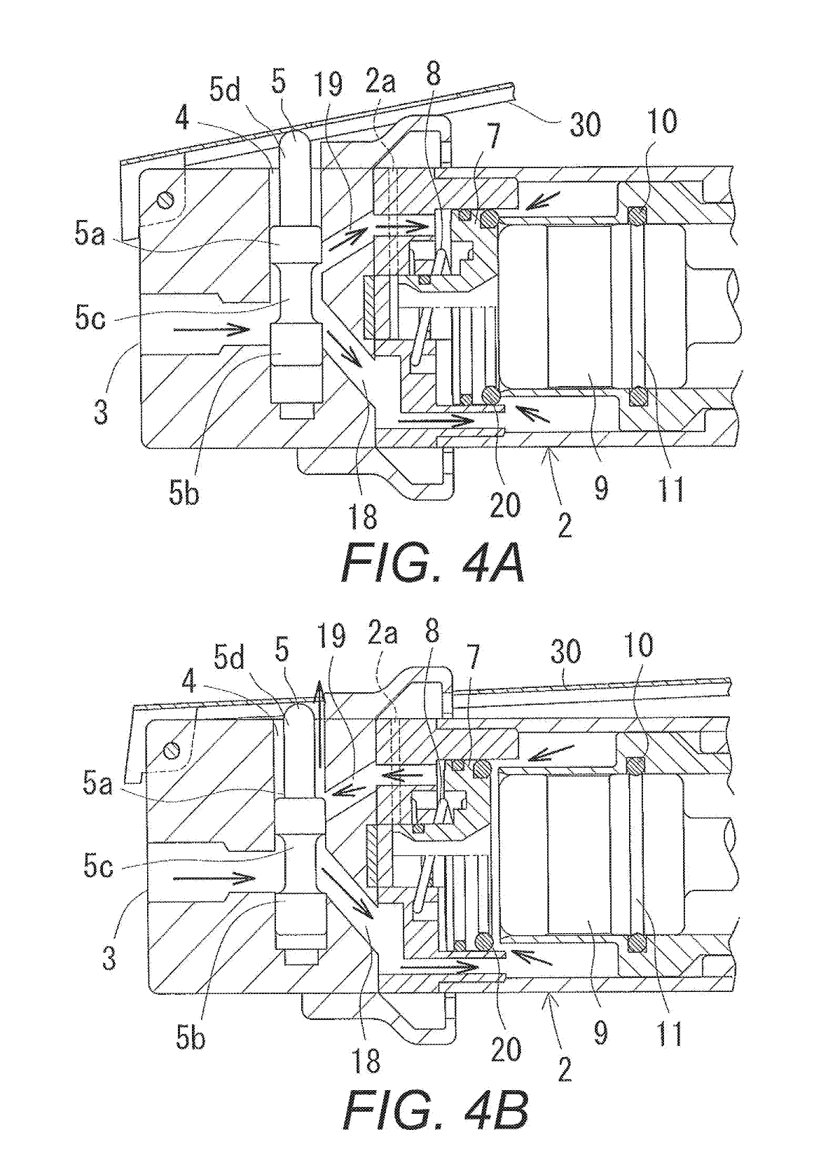

In the structure described above, during the normal time when the operation lever 30 is not operated as shown in FIG. 1, FIG. 2 and FIG. 4A, the operation switch 5 is arranged at a reference position where it is urged to the side of the operation lever 30, and the cylinder direction path 18 and the valve direction path 19 communicate with the compressed air introduction port 3. On the other hand, the cylinder direction path 18 is blocked by the O-ring 20 of the valve 7 so as to prevent air from flowing into the cylinder 6. The valve direction path 19 also communicates with the space in a rear side of the valve 7.

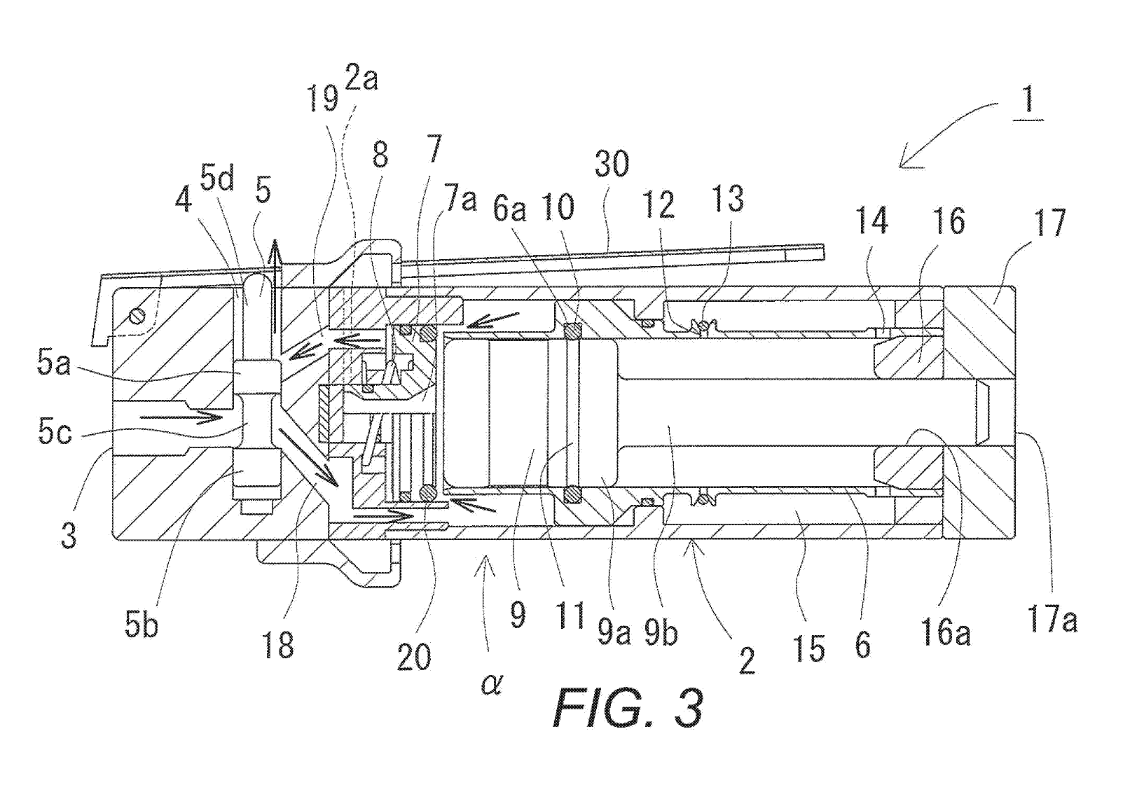

As shown in FIG. 3 and FIG. 4B, when the operation lever 30 is turned downward to push the operation switch 5, the gap between the operating part 5d and the switch hole 4 communicates with the valve direction path 19, and the compressed air within the valve direction path 19 flows through the switch hole 4 and is discharged to the outside. Accordingly, the pressure difference is produced between the front and the back sides of the valve 7, and the valve 7 moves backward due to the compressed air existing in the cylinder direction path 18. Backward moving of the valve 7 causes the cylinder direction path 18 to communicate with the cylinder 6 and the compressed air in the cylinder direction path 18 to be introduced into the cylinder 6. At this time, the backward moving of the valve 7 also causes the communication between the through hole 7a of the valve 7 and the airflow passage 2a to be blocked, and thus airflow is prevented.

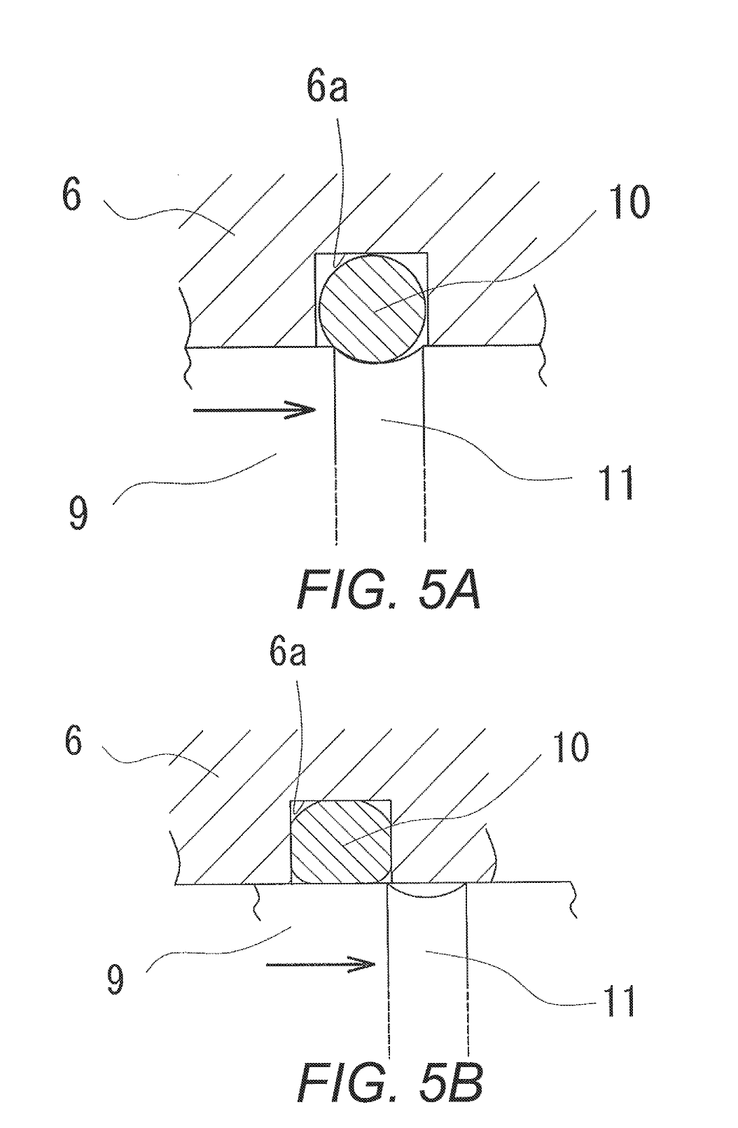

The compressed air introduced into the cylinder 6 urges the hammer 9 forward. Since the groove 11 formed on the outer periphery of the hammer 9 catches the O-ring 10 of the cylinder 6 (see FIG. 5A), the hammer 9 stays at the stop position α until the predetermined pressure is achieved. When the urging force exerted on the hammer 9 becomes larger than the locking force between the groove 11 and the O-ring 10, the O-ring 10 comes out of the groove 11 (see FIG. 5B), and the hammer 9 starts to move forward in the cylinder 6. At this time, until the hammer 9 passes by the position of the O-ring 10, the outer peripheral surface of the hammer 9 is brought into contact with the O-ring 10; however, when the whole hammer 9 passes by the position of the O-ring 10, the hammer 9 moves forward without receiving any resistance from the O-ring 10.

In the course of the hammer 9 moving forward, the compressed air in the front side of the hammer 9 in the cylinder 6 flows, as shown in FIG. 6, through the first air hole 12 and the second air hole 14 into the cylinder side chamber 15 to pressurize the internal pressure of the cylinder side chamber 15 to high pressure. On the other hand, the compressed air introduced from the compressed air introduction port 3 is set to the pressure value exceeding the internal pressure of the cylinder side chamber 15, and the driving force of the hammer 9 is secured from the internal pressure difference. The front end of the rod part 9b of the hammer 9 that has moved forward hits on the workpiece (striking object), which is not shown in the drawing, and applies the striking force on the workpiece.

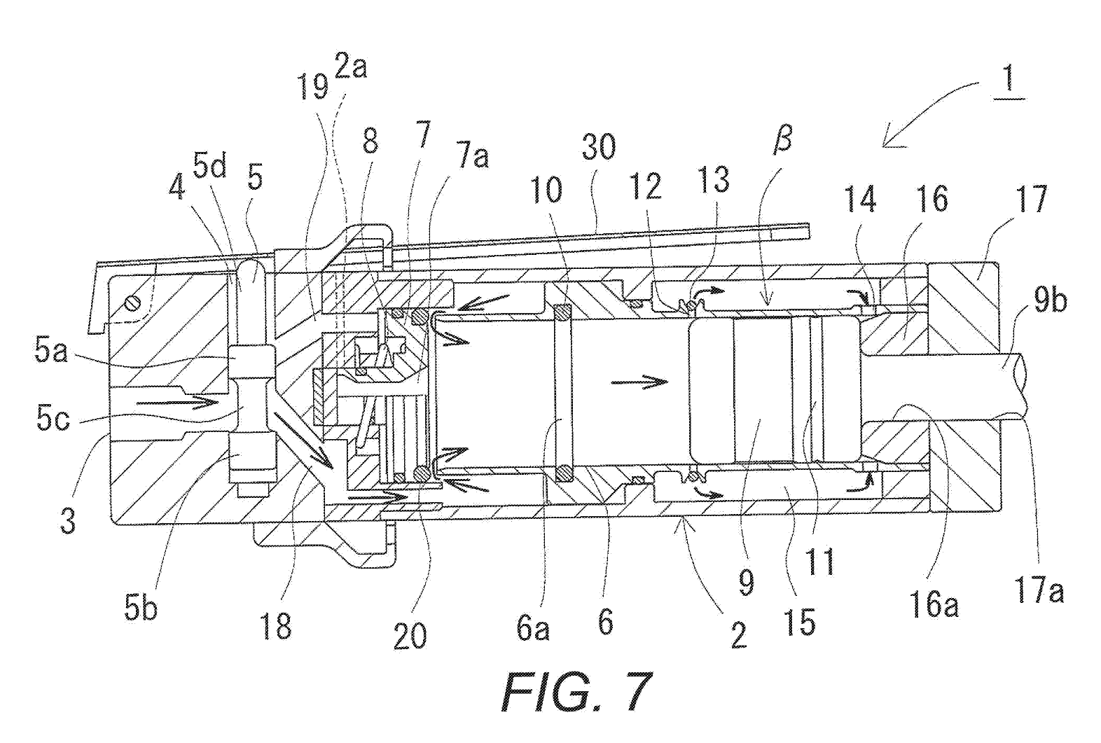

As shown in FIG. 6 and FIG. 7, when the hammer 9 reaches the impact position β, the hammer 9 abuts against the stopper member 16, and the first air hole 12 communicates with the inside of the cylinder 6 at this position. At this time, even in the state where the operation switch 5 is pushed, the valve 7 is maintained in a backward state by the pressure of the compressed air in the cylinder 6, and the blocking state is maintained between the through hole 7a of the valve 7 and the airflow passage 2a. Since the compressed air in the cylinder 6 is introduced into the cylinder side chamber 15 through the first air hole 12, the pressure difference is cancelled between the front and the back sides of the hammer 9, and the hammer 9 stops at the impact position β (see FIG. 7).

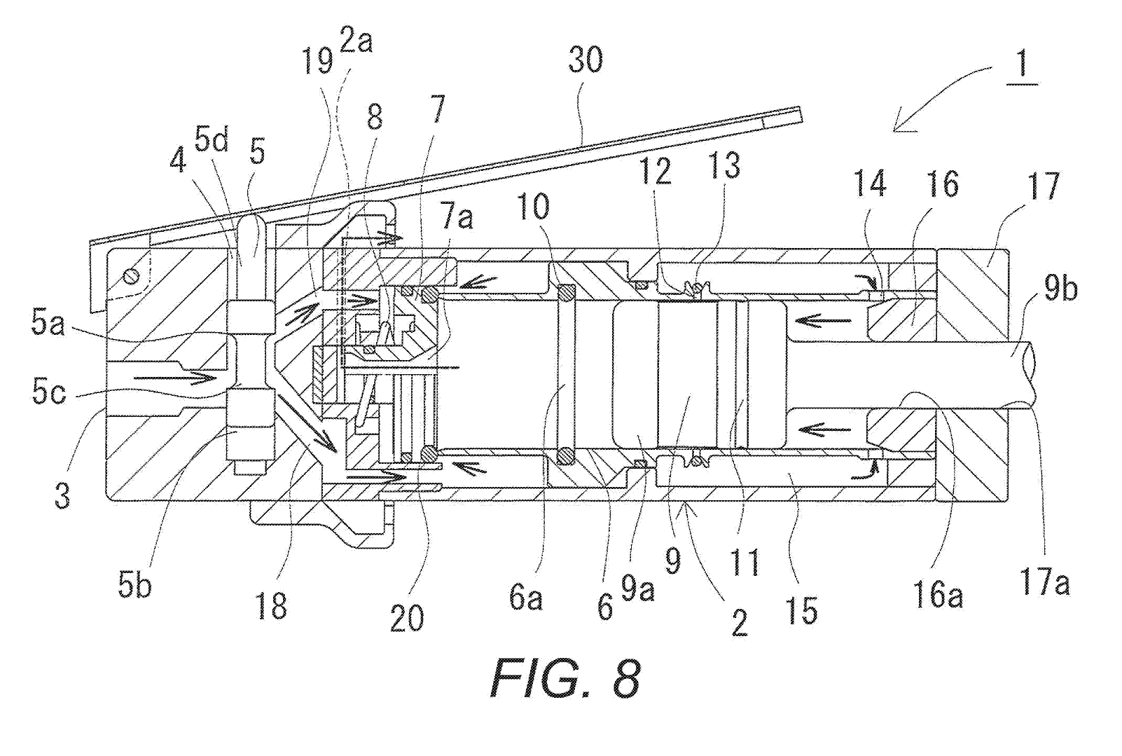

As shown in FIG. 8, when the operation lever 30 is turned to cause the operation switch 5 to protrude and thus returned to its initial reference position, the compressed air introduction port 3 communicates with the valve direction path 19, and the valve 7 moves forward by the pressure of the compressed air. Then, the through hole 7a of the valve 7 communicates with the airflow passage 2a, and the compressed air in the cylinder 6 is released to the outside through the through hole 7a and the airflow passage 2a. Accordingly, the pressure of the compressed air in the back side of the hammer 9 is reduced in the cylinder 6, the compressed air stored in the cylinder side chamber 15 flows into the cylinder 6 through the second air hole 14, and the hammer 9 is urged backward. The O-ring 13 serving as a one-way valve is attached on the first air hole 12, and thus the compressed air is prevented from flowing from the cylinder side chamber 15 into the cylinder 6 through the first air hole 12.

Then, the hammer 9 moves backward toward the stop position α and starts to reduce speed due to the resistance from the O-ring 10 at the point where the interference starts to occur between the outer peripheral surface of the hammer 9 and the O-ring 10. At the point where the groove 11 of the hammer 9 reaches the position of the O-ring 10, the groove 11 catches the O-ring 10, and the hammer 9 stops at the stop position α again.

According to the construction described so far, the internal structure of the air hammer tool 1 can be simplified. In addition, the hammer 9 can instantly be accelerated at the moment that the O-ring 10 comes out of the groove 11, and therefore the striking force of the hammer 9 can be secured adequately. Further, the O-ring 10 is arranged on the side of the cylinder 6, and the O-ring 10 does not come into contact with the hammer 9 after the hammer 9 passes by the position where the O-ring 10 is arranged. Therefore, the increase in speed of the hammer is not hindered by the friction resistance, and the abrasion of the O-ring 10 or the hammer 9 can be minimized.

The embodiments can be modified appropriately, and the configuration may be made such that the operator can properly operate the operation switch 5 in a direct manner. The number and the position of the first air hole 12 and the second air hole 14 can be determined appropriately within the range in which the mechanism can be achieved to implement the single-shot type function. Furthermore, the geometries of the groove 11 and the O-ring 10 can be defined arbitrarily.

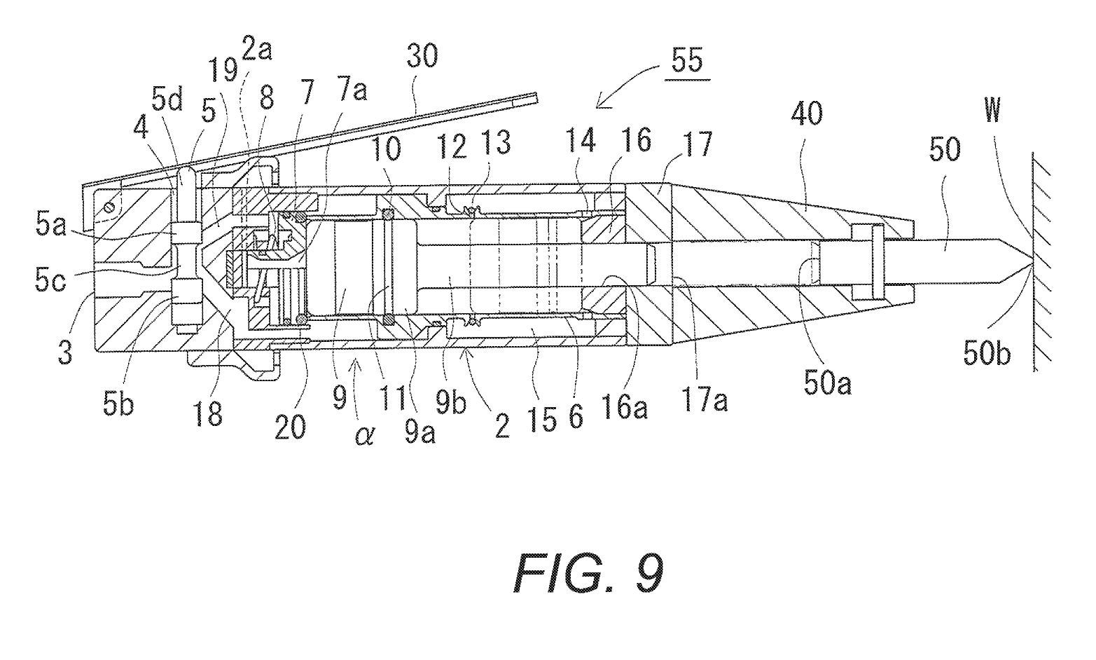

As shown in FIG. 9, the structure may be employed such that an end tool attachment member 40 is arranged in the front side of the blockage member 17, an end tool 50 such as the chisel is attached to the member, and the rod part 9b of the hammer 9 strikes a rear end 50a of the end tool 50. According to the above structure, the air hammer tool 55 can be achieved for applying the striking force on the workpiece W with the front end 50b of the end tool 50.

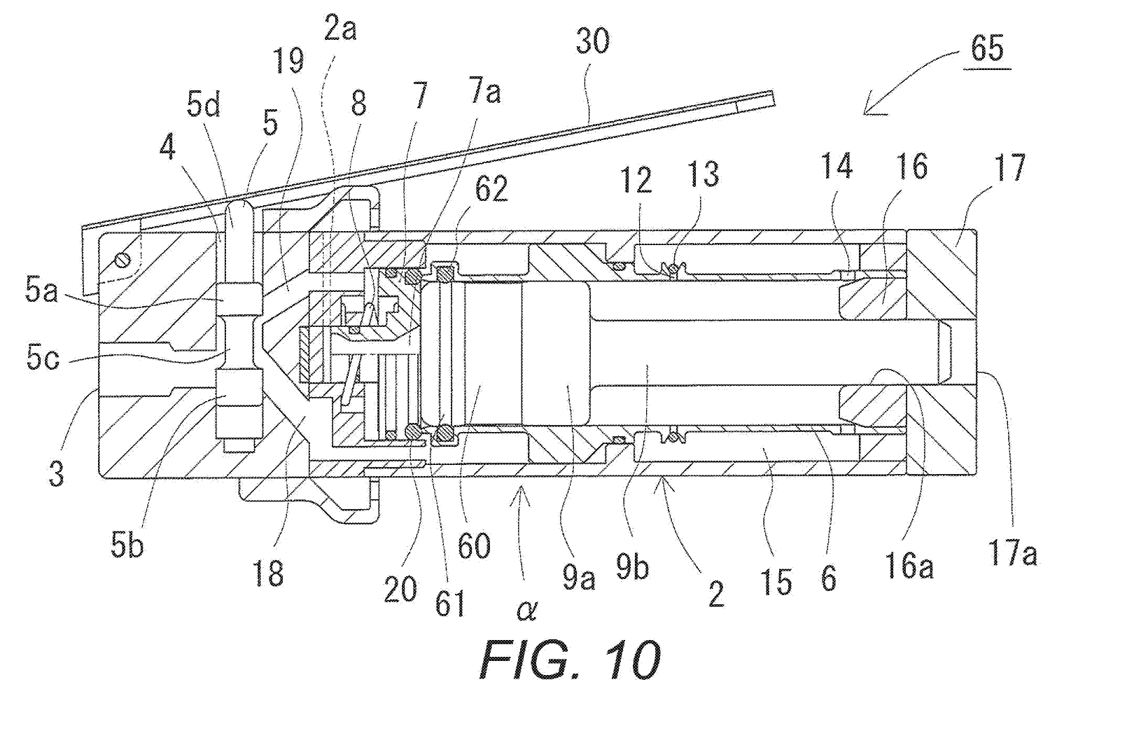

Furthermore, as shown in FIG. 10, the position of a groove 61 that is a recess on the hammer 60 may be changed along the axial direction of the hammer 60, and thus the striking force can be changed. Specifically, when the groove 61 is defined in the vicinity of the rear end of the hammer 60, in the air hammer tool 65, the contact time between the outer peripheral surface of the hammer 60 and the O-ring 62 shortens while the hammer 60 moves forward, the resistance from the O-ring 62 reduces, and thus the striking force improves. On the contrary, when the groove 61 is defined in the front side of the hammer 60, the contact time between the O-ring 62 and the hammer 60 lengthens while the hammer 60 moves forward, the resistance from the O-ring 62 increases, and thus the striking force reduces. The striking force can be adjusted by a proper change in the degree of engagement between the O-ring 62 and the groove 61.

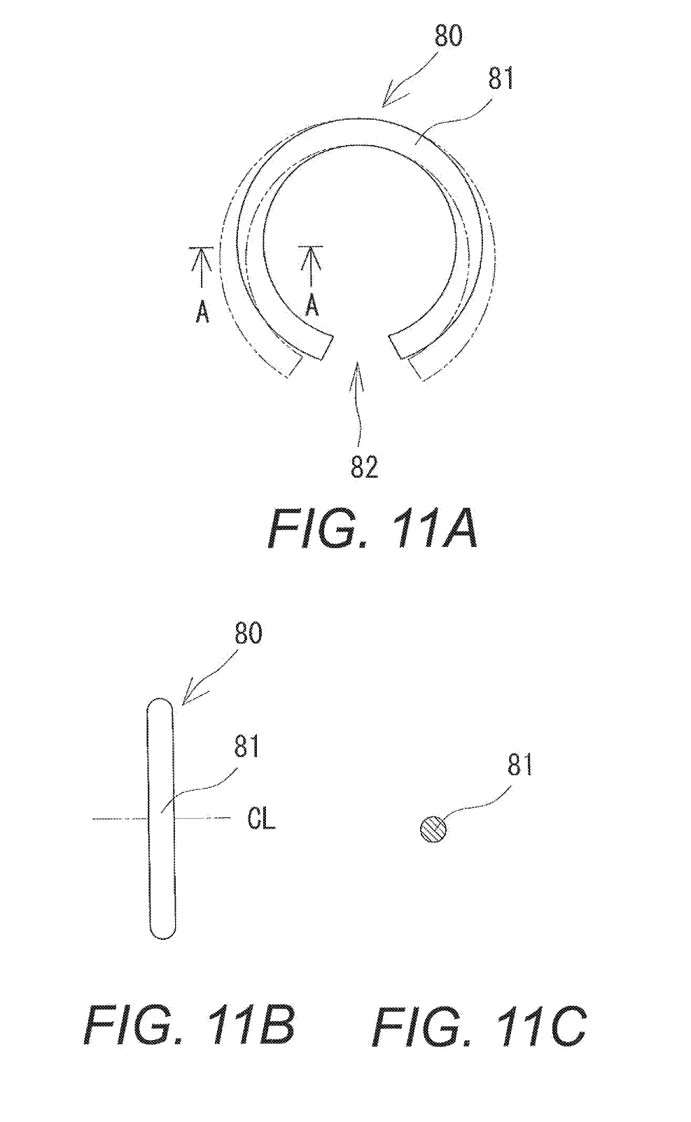

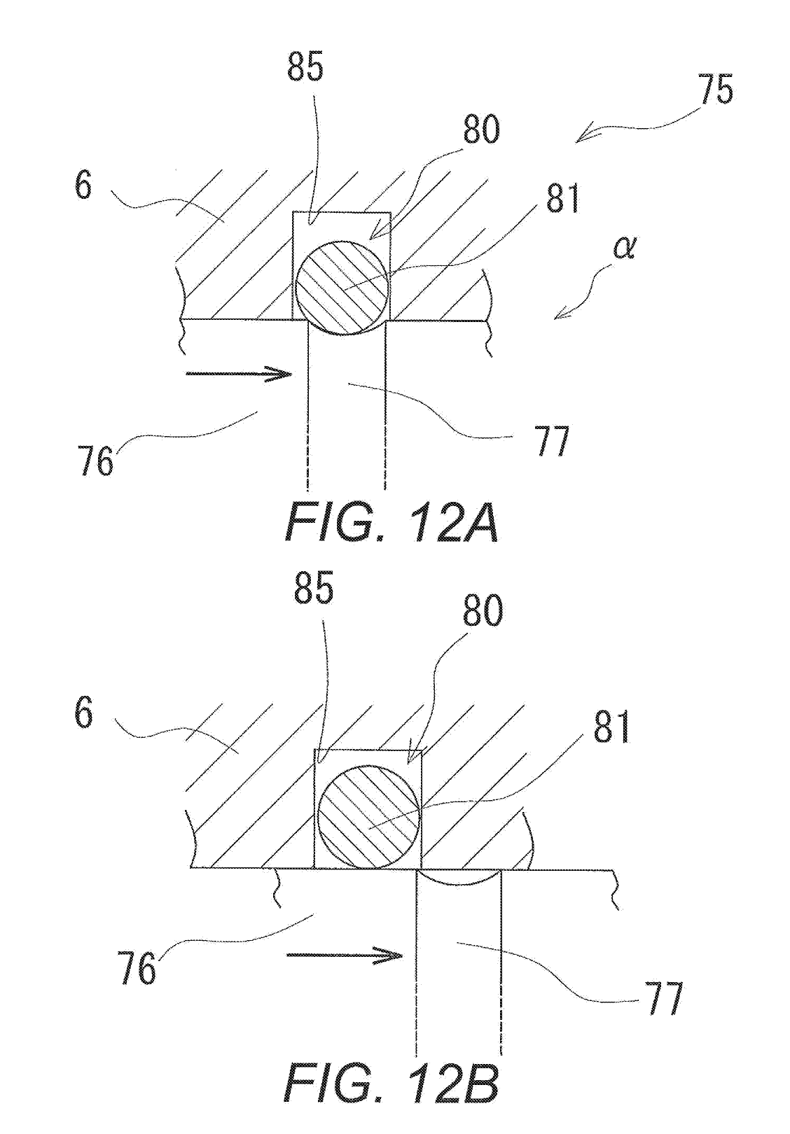

With reference to FIGS. 11A, 11B, 11C, 12A, and 12B, an air hammer tool 75 according to the present embodiment will be described next. Here, descriptions on points in common with those in the structure described above will be simplified or omitted, and the same reference numerals and symbols are used on the drawing.

The outer peripheral surface of the hammer 76 according to the present embodiment includes a recessed groove 77 formed along the circumferential direction, as shown in FIG 12. On the other hand, the inner peripheral surface of the cylinder 6 includes a holding recessed groove 85 formed along the circumferential direction of the cylinder 6.

In addition, a partially-removed ring body 80 as the elastic member is arranged in the holding recessed groove 85. As shown in FIGS. 11A, 11B, and 11C, the partially-removed ring body 80 is constructed with an annular wire material 81 made of metal and having a circular cross section. A part of the material is cut out, a gap 82 is formed, and thus the partially-removed ring body 80 elastically deforms in the radial direction to be capable of expanding or reducing its inside diameter. The holding recessed groove 85 in which the partially-removed ring body 80 is held in an elastically deformable manner in the radial direction constitutes the recess according to the embodiment of the present invention.

In the above structure, as shown in FIGS. 12A and 12B, when the hammer 76 is situated at the stop position α, the hammer 76 is fitted onto the ring of the partially-removed ring body 80 (see FIG. 12A). In other words, the recessed groove 77 of the hammer 76 engages with the partially-removed ring body 80, and thus the hammer 76 is positioned at the stop position α. Then, the compressed air is introduced while the hammer 76 is positioned at the stop position α, and the hammer 76 is urged forward.

When the above urging force exceeds the predetermined magnitude, as shown in FIG. 12B, the cross-sectional shape (circle) of the wire material 81 does not become deformed in the view that is cut in the plane including a center axis CL of the partially-removed ring body 80, and the inside diameter of the partially-removed ring body 80 expands. Therefore, the above engaged state is disengaged, and the hammer 76 leaves from the partially-removed ring body 80.

On the other hand, when the hammer 76 moves backward and fits onto the partially-removed ring body 80 to be engaged again, the cross-sectional shape (circle) of the wire material 81 constructing the partially-removed ring body 80 does not become deformed, and the inside diameter of the partially-removed ring body 80 expands. Preferably, the rear end of the hammer 76 that comes into contact with the partially-removed ring body 80 first in the process of being inserted into the partially-removed ring body 80 is made in a tapered shape in which the outside diameter decreases toward the rear end.

To describe again, the metallic partially-removed ring body 80 as the elastic member in the above structure does not deform its cross-sectional shape but can elastically deform the shape only in the radial direction within the holding recessed groove 85. Accordingly, the partially-removed ring body 80 does not get distorted in the direction of forward movement of the hammer 76 in the state where the pressure of the compressed air is exerted on the hammer 76 situated at the stop position α, and thus the force for holding the hammer 76 at the stop position α increases exponentially. Therefore, the hammer 76 can be accelerated more instantaneously.

It is desirable that the cross-sectional shape of the wire material 81 in the partially-removed ring body 80 be a perfect circle in view of securing strength, and the striking force may be adjusted through the change of a wire diameter. Specifically, when the wire diameter is increased, the stiffness of the partially-removed ring body 80 is improved, the holding force increases, the pressure of the compressed air can be pressurized to high pressure, and thus the striking force can be increased. On the other hand, when the wire diameter is reduced, the striking force can be decreased. The striking force may be adjusted through the change of the groove width or depth of the recessed groove 77 of the hammer 76. In addition, the striking force may be adjusted through the change of the groove width or depth of the holding recessed groove 85.

The elastic member according to the embodiment of the present invention is not limited to the elastic member described above, and other shapes or materials may be adopted. For example, the partially-removed ring body 80 is preferably made of metal but may be made of other hard materials such as rigid plastic.

According to one aspect of the present invention, a single-shot type air hammer tool includes a cylinder, a hammer provided inside the cylinder to freely slide back and forth, an operation switch for introducing compressed air into the cylinder, and an end tool which is mounted in a front side of said cylinder and on which said hammer strikes, for applying striking force to a workpiece W with an end of the end tool, in which, when the operation switch is operated once and the compressed air is introduced into the cylinder, said hammer moves forward from a stop position defined in the cylinder to an impact position where the hammer impacts on the end tool arranged at a front of the stop position, and after the hammer impacts on the end tool, the hammer moves backward toward said stop position and again stops at the stop position,

wherein an elastic member is located at a predetermined position that is on an inner peripheral surface of said cylinder and faces to said hammer situated at said stop position so as to protrude at least partially into the cylinder, a recess is set up to a hammer in the location which corresponds to the elastic member and the hammer situated at the stop position so as to catch the elastic member,

the hammer situated at the stop position is urged forward by the pressure of the compressed air introduced due to one operation of said operation switch, a locked state between said recess of the hammer and said elastic member is disengaged, the hammer starts to move forward, the recess of the hammer moving backward from said impact position to the stop position within the cylinder catches the elastic member again, and thus the hammer stops at the stop position,

said elastic member is configured with a partially-removed ring body constructed with an annular wire material made of metal and having a circular cross section in which part of the material is removed, a gap is formed, and thus the partially-removed ring body elastically deforms only in the radial direction to be capable of freely expanding or reducing its inside diameter,

a recess in which said partially-removed ring body is held in an elastically deformable manner only in the radial direction is formed on the inner peripheral surface of said cylinder,

when said hammer is situated at the stop position, the hammer is fitted onto the ring of the partially-removed ring body,

in a state where the hammer situated at said stop position is urged forward, the cross-sectional shape of said wire material does not become deformed in the view that is cut in the plane including a center axis of said partially-removed ring body, the inside diameter of the partially-removed ring body expands, and thus said locked state is disengaged, and the hammer leaves from the partially-removed ring body, and

when the hammer moves backward and fits onto said partially-removed ring body to be locked again, said cross-sectional shape of the wire material forming the partially-removed ring body does not become deformed, and the inside diameter of the partially-removed ring body expands.

According to the above structure, the single-shot type air hammer tool can be provided with the simple internal structure. The predetermined amount of compressed air can be introduced into the cylinder until the elastic member leaves from the recess of the hammer, the hammer can be accelerated instantaneously at the moment which the elastic member leaves from the recess, and therefore, a sufficient striking force of the hammer can be secured. In addition, the elastic member is arranged on the side of the cylinder, and the elastic member does not come into contact with the hammer after the hammer passes by the position where the elastic member is arranged. Therefore, the increase in speed of the hammer is not hindered, and the abrasion of the the elastic member or the hammer can be minimized.

For example, there is a case where the weight of the hammer needs to be heavy because the hammer is required to apply the sufficient striking force as the impact tool at the site of use such as a construction site or a plant. If the elastic member is constructed with, for example, a common rubber O-ring, the O-ring easily becomes deformed and gets crushed out of shape, and thus the hammer cannot be held at the stop position until the desired air pressure is achieved. In addition, there is a problem in the rubber O-ring, for example, that when the O-ring is expanded in the radial direction, the wire diameter becomes thin, and the O-ring tends to easily break.

Therefore, the above structure has been proposed in order that a heavy-weight hammer is properly stopped at the stop position even when high air pressure is applied. In other words, the structure is made such that the elastic member elastically deforms only in the radial direction without deforming the cross-sectional shape, and therefore the force for holding the hammer increases exponentially. Specifically, when the hammer leaves from the partially-removed ring body, the cross-sectional shape of the partially-removed ring body does not get distorted in the direction of forward movement of the hammer. Therefore, the force for holding the hammer at the stop position increases, and the hammer can be accelerated more instantaneously.

Preferably, a recess in which the partially-removed ring body is held in an elastically deformable manner in the radial direction is formed on the inner peripheral surface of the cylinder.

According to the above structure, the partially-removed ring body can be arranged at the predetermined position with respect to the hammer moving back and forth every time the operation switch is operated.

In addition, it is desirable that the striking object is an end tool mounted on the front side of the cylinder.

According to the above structure, the end tool having different end shapes can be used for different purposes to perform the tasks. Even when the end of the end tool is worn and needs replacing, only the end tool may be replaced, and therefore the service for maintenance of the whole air hammer tool becomes very easy.

In addition, it is preferable that the elastic member is a partially-removed ring body made of metal.

According to the above structure, when the hammer leaves from the partially-removed ring body, the cross-sectional shape of the partially-removed ring body can securely be prevented from getting distorted in the direction of forward movement of the hammer.

According to another aspect of the present invention a method of adjusting a striking force of the single-shot type air hammer tool described above is characterized in that the striking force of said hammer is changed through a change of the position of the recess catching said elastic member along the axial direction of said hammer.

In the above structure, when the position of the recess is changed, the time in which the outer peripheral surface of the hammer comes into contact with the elastic member varies in the case where the hammer moves forward, and thus a magnitude of the velocity during the forward movement of the hammer changes. Consequently, changing the position of the recess to extend the contact time between the hammer and the elastic member can make the velocity during the forward movement of the hammer reduced, or shortening the contact time between the hammer and the elastic member can make the velocity during the forward movement of the hammer increased. Therefore, an optimum striking force for the air hammer tool can be set.

In addition, the striking force of the hammer may be changed through a change of the depth of the recess which is formed on the inner peripheral surface of the cylinder and in which the partially-removed ring body is held in the elastically deformable manner in the radial direction.

In the above structure, the range of expanding motion of the elastic member is changed through the change of the depth of the recess, and thus the force for holding the hammer at the stop position can be changed in accordance with the range of expanding motion. Therefore, the acceleration of the hammer at the moment in which the hammer leaves from the elastic member can be changed, and the striking force can be adjusted accordingly.

The single-shot type air hammer tool according to the embodiment of the present invention can prevent the attenuation of the striking force due to the friction resistance as quickly as possible since the contact time between the elastic member for securing the airtightness and the hammer is shortened and also can apply the proper striking force because of the increase in the holding force for positioning the hammer at the stop position.

In addition, the method of adjusting the striking force according to the embodiment of the present invention can finely adjust the striking force in the single-shot type air hammer tool described above.

Obviously, numerous modifications and variations of the present invention are possible in light of the above teachings. It is therefore to be understood that within the scope of the appended claims, the invention may be practiced otherwise than as specifically described herein.

What is claimed is:

1. A single-shot type air hammer tool, comprising a cylinder, a hammer provided inside the cylinder to freely slide back and forth, an operation switch for introducing compressed air into the cylinder, and an end tool which is mounted in a front side of said cylinder and on which said hammer strikes, for applying striking force to a workpiece W with an end of the end tool, in which, when the operation switch is operated once and the compressed air is introduced into the cylinder, said hammer moves forward from a stop position defined in the cylinder to an impact position where the hammer impacts on the end tool arranged at a front of the stop position, and after the hammer impacts on the end tool, the hammer moves backward toward said stop position and again stops at the stop position,
wherein an elastic member is located at a predetermined position that is on an inner peripheral surface of said cylinder and faces to said hammer situated at said stop position so as to protrude at least partially into the cylinder, a recess is set up to a hammer in the location which corresponds to the elastic member and the hammer situated at the stop position so as to catch the elastic member,
the hammer situated at the stop position is urged forward by the pressure of the compressed air introduced due to one operation of said operation switch, a locked state between said recess of the hammer and said elastic member is disengaged, the hammer starts to move forward, the recess of the hammer moving backward from said impact position to the stop position within the cylinder catches the elastic member again, and thus the hammer stops at the stop position,
said elastic member is configured with a partially-removed ring body constructed with an annular wire material made of metal and having a circular cross section in which part of the material is removed, a gap is formed, and thus the partially-removed ring body elastically deforms only in the radial direction to be capable of freely expanding or reducing its inside diameter,
a recess in which said partially-removed ring body is held in an elastically deformable manner only in the radial direction is formed on the inner peripheral surface of said cylinder,
when said hammer is situated at the stop position, the hammer is fitted onto the ring of the partially-removed ring body,
in a state where the hammer situated at said stop position is urged forward, the cross-sectional shape of said wire material does not become deformed in the view that is cut in the plane including a center axis of said partially-removed ring body, the inside diameter of the partially-removed ring body expands, and thus said locked state is disengaged, and the hammer leaves from the partially-removed ring body, and
when the hammer moves backward and fits onto said partially-removed ring body to be locked again, said cross-sectional shape of the wire material forming the partially-removed ring body does not become deformed, and the inside diameter of the partially-removed ring body expands.

2. A method of adjusting a striking force of the single-shot type air hammer tool according to claim 1,
wherein the striking force of said hammer is changed through a change of the position of the recess of the hammer catching said elastic member along the axial direction of said hammer.

3. A method of adjusting a striking force of the single-shot type air hammer tool according to claim 1,
wherein the striking force of said hammer is changed through a change of the depth of the recess which is formed on the inner peripheral surface of said cylinder and in which said partially-removed ring body is received in the elastically deformable manner in the radial direction.
